(19) United States
(12) Patent Application Publication
(10) Pub. No.: US 2018/0290599 A1
(43) Pub. Date: Oct. 11, 2018

(54) SEPARATING OR HOLDING NET

(71) Applicant: NOELLE-PEPIN GmbH & Co. KG, Schwelm (DE)

(72) Inventor: Marc EMDE, Ennepetal (DE)

(21) Appl. No.: 16/006,257

(22) Filed: Jun. 12, 2018

Related U.S. Application Data
(63) Continuation-in-part of application No. 14/715,731, filed on May 19, 2015.

(30) Foreign Application Priority Data
Jun. 7, 2014 (DE) 102014008526.0

(51) Int. Cl. B60R 7/00; B60R 7/04

(52) U.S. Cl. CPC B60R 7/005; B60R 7/043

(57) ABSTRACT

A net having an elastic netting part having a plurality of rhombic mesh openings and formed by a plurality of strings running at an angle to one another, each formed by a plurality of filaments, and each consisting of a succession of string segments defining the rhombic mesh openings. The string segments of each string differ depending on location in the netting part from one another in type, dimension, or composition of the material thereof. An elastic edge member extending along at least on a part of an edge of the net has only a very low amount of slack or no slack.

### CROSS REFERENCE TO RELATED APPLICATIONS

This application is a continuation-in-part of copending application 14/714,731 filed 19 May 2015 with a claim to the priority of German patent application 10 2014 008 526.0 filed 06 Jun. 2014.

### FIELD OF THE INVENTION

The present invention relates to a separating or holding net. More particularly this invention concerns such a net used with an upright surface to form a stowage pocket, for instance on a vehicle seat back.

### BACKGROUND OF THE INVENTION

Such a separating or holding net comprises an elastic netting part whose rhombic mesh openings are formed of groups of strings running at an angle to one another and each comprising a plurality of strings and an elastic edge member extending along at least part of the net mesh edge.

With such a separating or holding net known from the prior art, typically the part of the netting edge provided with an elastic edge member has a relatively large amount of slack, and as a consequence the separating or holding net often fails to meet the aesthetic or sometimes even technical requirements that have been set forth.

### OBJECTS OF THE INVENTION It is therefore an object of the present invention to provide an improved separating or holding net.

Another object is the provision of such an improved separating or holding net that overcomes the above-given disadvantages, in particular with which the known technical and/or aesthetic disadvantages are overcome.

### SUMMARY OF THE INVENTION

This object is attained according to the invention by a net having an elastic netting part having a plurality of rhombic mesh openings and formed by a plurality of strings running at an angle to one another, each formed by a plurality of filaments, and each consisting of a succession of string segments defining the rhombic mesh openings. The string segments of each string differ depending on location in the netting part from one another in type, dimension, or composition of the material thereof. An elastic edge member extending along at least on a part of an edge of the net has only a very low amount of slack or no slack.

In other words the strings are designed in accordance with the arrangement thereof in the netting part so that the elastic edge member of the separating or holding net, in the assembled state thereof, has only a very small amount of slack or no slack. First, the appearance of the separating or holding net according to the invention is thereby considerably improved, and also the technical disadvantages due to an edge region having a relatively undefined design are reliably eliminated.

The strings of the separating or holding net according to the invention differ in one embodiment of the invention, in terms of the type and/or composition of the material thereof, in accordance with the arrangement thereof in the netting part.

Cumulatively or alternatively, the strings may also differ in terms of the amount of the material used therefor, in accordance with the arrangement thereof in the netting part.

It is further possible for the strings to differ in terms of the amount of tension to which they are subjected in the manufacture of the netting part, in accordance with the arrangement thereof in the netting part.

According to an advantageous embodiment, the separating or holding net according to the invention comprises a plurality of elastic edge members that all have a very small amount of slack or no slack in the assembled state of the separating or holding net.

According to another advantageous embodiment of the separating or holding net according to the invention, parts of the netting edge that are not provided with the at least one elastic edge member are provided with at least one relatively stiff edge part.

Advantageously, couplings are arranged between the at least one elastic edge member and the at least one relatively stiff edge part.

### BRIEF DESCRIPTION OF THE DRAWING

The above and other objects, features, and advantages will become more readily apparent from the following description, reference being made to the accompanying drawing in which:

FIG. 1 is a schematic view of a separating or holding net according to the invention; and

FIG. 2 is a similar view of a prior-art such net.

### SPECIFIC DESCRIPTION OF THE INVENTION

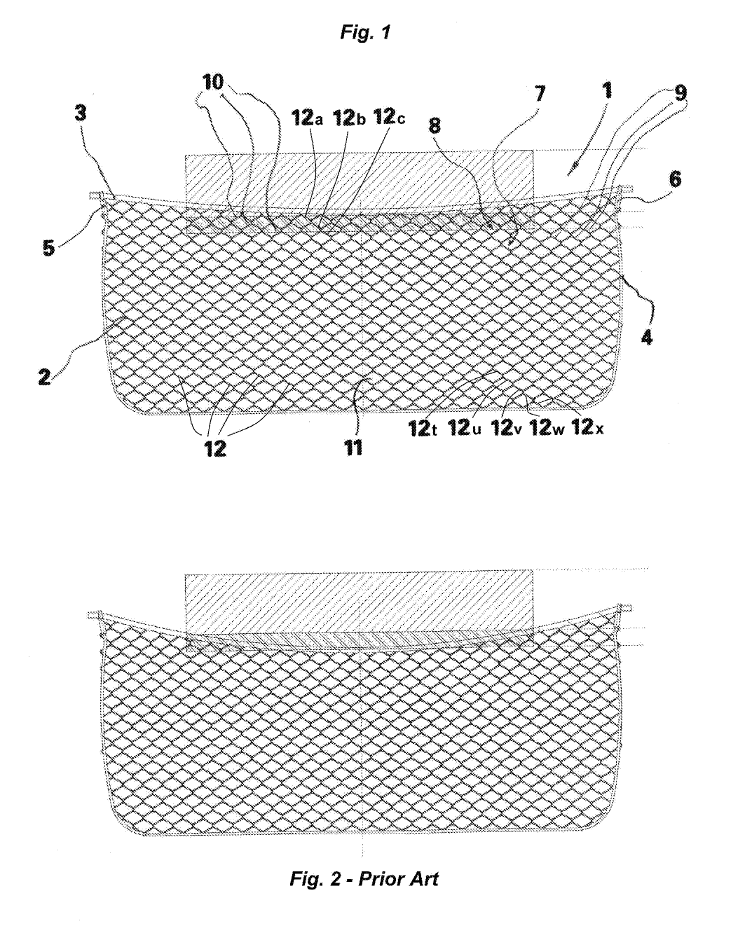

As seen in FIG. 1, a separating or holding net 1 according to the invention has a netting part 2, an elastic edge member 3, a relatively stiff edge part 4, and two couplings 5 and 6 that connect ends of the relatively stiff edge part 4 and the elastic edge member 3.

The netting part 2 is woven from two groups of strings 7 and 8 running at an angle to one another in the illustrated embodiment of the separating or holding net 1 according to the invention. Each of these two groups of strings 7 and 8 is composed of a plurality of strings 9 and 10 that run approximately in parallel to one another in the illustrated embodiment, the strings 9 and 10 being interconnected so as to form rhombic mesh openings 11.

At the upper netting edge, the netting part 2 is provided with the elastic edge member 3 formed as an elastic band in the illustrated embodiment. The elastic band 3 is supported by the two couplings 5 and 6 that are each formed as elastic band couplings 5 and 6 fixed to the free ends of the relatively stiff edge part 4 that is formed as a wire frame. The two elastic band couplings 5 and 6 connect the elastic band 3 and the wire frame 4 to one another.

The separating or holding net 1 according to the invention illustrated in FIG. 1 is formed by a multiplicity of strings 12, four of which form one mesh opening or rhombus 11 and themselves forming the elastic netting part 2. Each of the diagonally extending strings 12 is formed by a succession of individual string segments shown at 12a, 12b, 12c . . . 12t, 12u, 12v, 12w, and 12x that different from one another. The difference can be the result of prestretching during manufacture, diameter, type of plastic, or other factor so that each of the segments 12a-12x of each string 12 is different from the other segments of the same string 12.

An intended state of tension of a net string 12 in the assembled state of the separating or holding net 1 according to the invention is derived on the basis of the respective arrangement of the net string 12 within the netting part 2. In the case of the separating or holding net 1 according to the invention, this is taken into account when the relevant net string section 12 is designed in order to ensure that in the illustrated embodiment the elastic band 3 has no slack or the smallest amount of slack possible.

This can be accomplished, for example, when the strings 12 differ in terms of type and/or composition of the material thereof, in terms of the amount of the material used therefor, and/or in terms of the amount of tension to which they are subjected in the manufacture of the netting part 2 in accordance with their position in the netting part.

FIG. 2 illustrates, by way of comparative example, a separating or holding net corresponding to the prior art in which the strings 12 of the netting part 2 are designed and produced in the manner known in the prior art. A comparison of FIGS. 1 and 2 demonstrates that the slack of the elastic band 3 in the case of the separating or holding net according to the invention is considerably less than with the separating or holding net according to the prior art.

I claim:

1. A separating or holding net comprising:
an elastic netting part formed by a plurality of crossing strings running at an angle to one another to define rhombic mesh openings, each string being formed by a plurality of filaments and consisting of a succession of string segments defining the respective rhombic mesh openings, the string segments of each string differing depending on location in the netting part from one another in type, dimension, or composition of the material thereof; and
an elastic edge member at least on a part of an edge of the net and having only a very low amount of slack or no slack, the filaments.

2. The net defined in claim 1, wherein the elastic edge member has a very low amount of slack or no slack in the assembled state of the separating or holding net.

3. The net defined in claim 1, wherein parts of the netting edge that are not provided with the elastic edge member are provided with at least one relatively stiff edge part.

4. The net defined in claim 3, further comprising:
couplings between ends of the elastic edge member and ends of the relatively stiff edge part.
